(19) United States
(12) Patent Application Publication
(10) Pub. No.: US 2017/0020164 A1
(43) Pub. Date: Jan. 26, 2017

(54) RICE SHEET

(71) Applicant: Shinichi SEKIMORI, San Jose, CA (US)

(72) Inventor: Shinichi SEKIMORI, San Jose, CA (US)

(21) Appl. No.: 14/804,022

(22) Filed: Jul. 20, 2015

(51) Int. Cl. A23L 1/36

(52) U.S. Cl. CPC A23L 1/164; A23L 1/1641; A23V 2002/00

(57) ABSTRACT

A rice sheet is formed of cooked rice. The cooked rice is compressed into a sheet-shape to have a reduced volume which is equal to or less than one half of an original volume of the cooked rice before the compression. The rice sheet is not cracked or broken when it is folded or rolled around an ingredient.

### BACKGROUND OF THE INVENTION

1. Field of the Invention

The present invention relates to a sheet-shaped food. More specifically, the present invention relates to a rice sheet suitable for wrapping ingredients therein to consume.

2. Description of the Related Art

Rice-based food and snacks include sushi and rice balls which are well known among others. Cooked rice is also formed into a sheet-shape and to make rice-sheet sandwiches and rice-sheet wraps. For example, U.S. Patent Application Publication No. 2001/0129818 describes a thin rice sheet with a thickness of 10 mm or less, more specifically, about 5 mm. The rice sheet is formed by surface-gelatinizing rice grains in boiled water in a first heating step with the central portions remain uncooked (not gelatinized), lightly kneading and shaping the half-cooked rice into a ball, and then pressing and shaping into a round rice sheet using a petri dish. The half-cooked rice sheet is then fully cooked in a second heating step by steam heating and hot water heating which are simultaneously or subsequently performed, followed by an optional baking step to obtain crisp surfaces.

However, since the thus-made cooked rice sheet tends to crack or break, it is necessary to add ungelatinized rice powder (Joshinko). Such rice powder is added to the half-cooked rice after the first heating step before kneading, or dissolved into the hot water in the second heating step so as to enhance adhesiveness among the cooked rice grains. In addition, it was found that such a rice sheet was still easily cracked or broken when rolled or folded around ingredients.

Japanese Patent Publication No. 2003-38110 describes a rice sheet having a thickness of 5 mm to 15 mm or 5 mm to 10 mm, which is made by cooing rice in a sheet-shaped mold.

### BRIEF DESCRIPTION OF THE INVENTION

The embodiments of the present invention provide a rice sheet formed of cooked rice which is not cracked or broken when it is wrapped, folded or rolled around an ingredient. The cooked rice is compressed into a sheet-shape to have a reduced volume which is equal to or less than one half of the original volume of the cooked rice before the compression. The reduced volume may be about one half of the original volume.

The rice sheet may have a thickness less than 3 mm. Alternately, the rice sheet may have a thickness between 3 mm to 8 mm.

The rice sheet is capable of being wrapped, folded, or rolled to hold an ingredient therein without cracking. At least one surface of the rice sheet is heat-dried to reduce stickiness thereof while an inside of the rice sheet maintains softness to be wrapped, folded, or rolled without cracks. When the rice sheet is wrapped, folded, or rolled, overlapping portions of the rice sheet are capable of adhering to each other when pressed onto each other. That is, the surface of the rice sheet in accordance with one embodiment of the present invention is not sticky when it is being handled to make a food product, yet it is possible to stick overlapping portions of the rice sheet together to maintain the wrapped, folded, or rolled shape so as to hold the ingredient therein.

When the cooked rice is formed into the rice sheet, a direction of a compressing force applied to the cooked rice changes during the compression. In other words, the cooked rice is kneaded in different directions so as to make a dense and packed rice sheet.

The cooked rice may include white cooked rice and brown cooked rice. The rice sheet may contain a seasoning which has been mixed with the cooked rice. The rice sheet may include a seasoning applied to a surface thereof. Furthermore, the rice sheet may have a patterned seaweed paper on a surface thereof.

In one aspect of the invention, a food product includes the rice sheet and an ingredient wrapped with the rice sheet. The rice sheet does not have cracks where the rice sheet is folded. The rice sheet has overlapping portions pressed to each other so as to retain a wrapping shape thereof.

### BRIEF DESCRIPTION OF THE DRAWINGS

The present invention is illustrated by way of example, and not by way of limitation, in the FIG.s of the accompanying drawings and in which like reference numerals refer to similar elements and in which:

FIG. 1 is a diagram schematically illustrating a rice sheet in accordance with one embodiment of the present invention.

FIGS. 2A and 2B are diagrams schematically illustrating an example of a mold for making a rice sheet in accordance with one embodiment of the present invention.

FIGS. 3A to 3C are diagrams schematically illustrating a process for making a rice sheet in accordance with one embodiment of the present invention.

FIG. 3D is a diagram schematically illustrating a mold and a compressing tool in accordance with one embodiment of the present invention.

FIG. 4 is a diagram schematically illustrating a cross sectional view of a rice sheet in the mold.

FIGS. 5A and 5B are diagrams schematically illustrating cross sectional views of an example of using a food wrapping film to make a rice sheet in accordance with one embodiment of the present invention.

FIG. 5C is a diagram schematically illustrating a rice sheet having a food wrapping film on a surface thereof in accordance with one embodiment of the present invention.

FIG. 5D is a diagram schematically illustrating a plurality of film-lined rice sheets stacked for storage or packaging in accordance with one embodiment of the present invention.

FIG. 6A is a diagram schematically illustrating a cross sectional view of an example of using food wrapping films to make a rice sheet in accordance with one embodiment of the present invention.

FIG. 6B is a diagram schematically illustrating a cross sectional view of a rice sheet having a pair of food wrapping films on both of the surfaces in accordance with one embodiment of the present invention.

FIGS. 7A through 7F are diagrams schematically illustrating examples of food products using the rice sheet in accordance with embodiments of the present invention, where FIGS. 7E and 7F show cross sectional views.

FIG. 8A through 8C are diagrams schematically illustrating examples of a rice sheet having a patterned seaweed paper and a corresponding food product in accordance with embodiments of the present invention.

### DETAILED DESCRIPTION OF EMBODIMENTS OF THE INVENTION

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

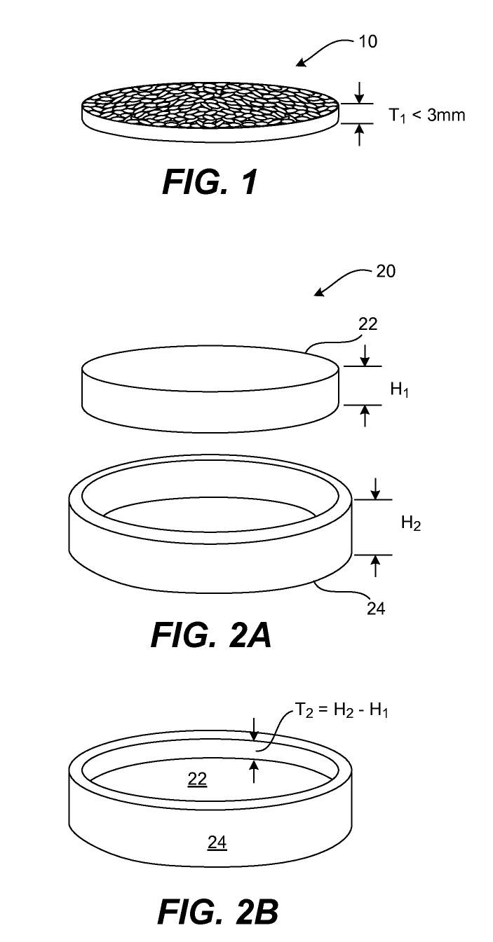

FIG. 1 shows an example of a rice sheet 10 in accordance with one embodiment of the present invention. The rice sheet 10 may have a circular or round shape. The rice sheet 10 is formed of cooked rice by compressing the cooked rice into a sheet shape by applying a pressure. The cooked rice is compressed into the sheet shape so as to have a reduced volume which is equal to or less than one half of the original volume of the cooked rice before the compression. Preferably, the rice sheet 10 has a thickness less than 3 mm. In other applications, the rice sheet 10 may have a thickness between 3 mm to 8 mm. Although the rice sheet 10 is described to have a circular or round shape in this description, the rice sheet 10 may be in any shape, such as square, rectangular, triangle, semicircular, quadrant, and the like.

The cooked rice may be prepared in a conventional way. For example, measured raw rice (e.g., 20 cups) is washed or rinsed with water, and then put in a suitable rice cooker or pot. Water is measured (for example, 22-24 cups) and added to rice cooker or pot. Optionally, the water-added rice may be left for 20 minutes to several hours until the rice grains absorb water. The rice is then heated for about 15 minutes (or until fully cooked) in the boiled water, and the boiled rice is allowed to settle (for example, about 20 minutes). The rice is gelatinized and the surface thereof becomes sticky with starch. The rice may be slightly undercooked so long as the surface of each rice grain is sticky with the gelatinized rice starch.

The cooked rice is softened by absorbing sufficient water under the heat, and the rice grain's surfaces are covered with gelatinized rice starch coming from inside the grains such that the rice grains easily stick to each other. The stickiness or adhesiveness remains unless the rice grains are dried or cooled down below the room temperature (for example, 15° C. or lower). The stickiness of the cooked rice can be enhanced by mixing sticky rice.

The rice used to make the rice sheet 10 may be nonglutinous rice, glutinous rice (sticky rice), or mixture thereof. The rice may be fully polished rice, half-polished rice, unpolished rice (brown rice), or a mixture thereof. Wild rice may also be used or mixed so long as it contains sufficient starch to stick together when it is cooked and pressed. In accordance with one embodiment of the present invention, barley may also be mixed with rice.

The cooked rice is measured and placed into a mold 20 to be formed into a sheet. FIGS. 2A and 2B show an example of the mold 20 which includes a base 22 and a ring 24. The base 22 has a height H1, and the ring 24 has a height H2 greater than the height H1. The base 22 is removably accommodated within the ring 24 such that the difference in the heights (H2—H1) provides a thickness of the rice sheet 10. The mold 20 may have a diameter D1 of 6 to 12 inches, or 20 to 30 cm. Although the mold 20 has a circular shape in this example, the shape of the mold is not limited to a specific shape. The mold 20 may have larger dimensions, and the rice sheet 10 may be cut into smaller pieces.

The base 22 may be made of a material from which the rice sheet 10 is easily separated, for example, silicon resin or the like. Such a silicon resin base is flexible and thus easier to remove the rice sheet therefrom. The ring 24 may be made of iron, stainless steel, or the like. The mold 20 may be Teflon®-coated. The mold 20 may be lightly coated with edible oil before placing the cooked rice therein, such that the cooked rice does not stick to the mold 24.

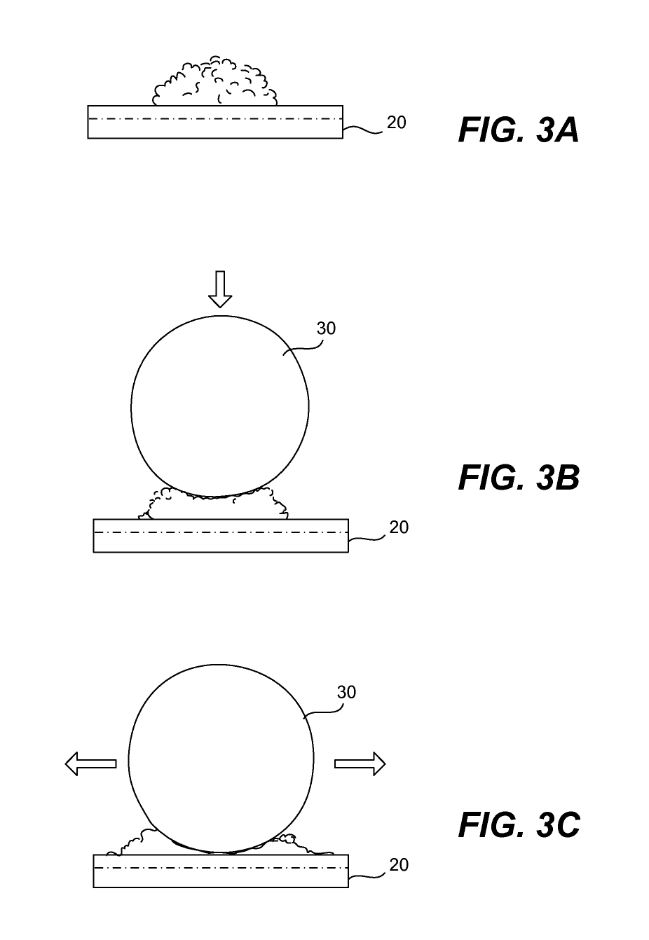

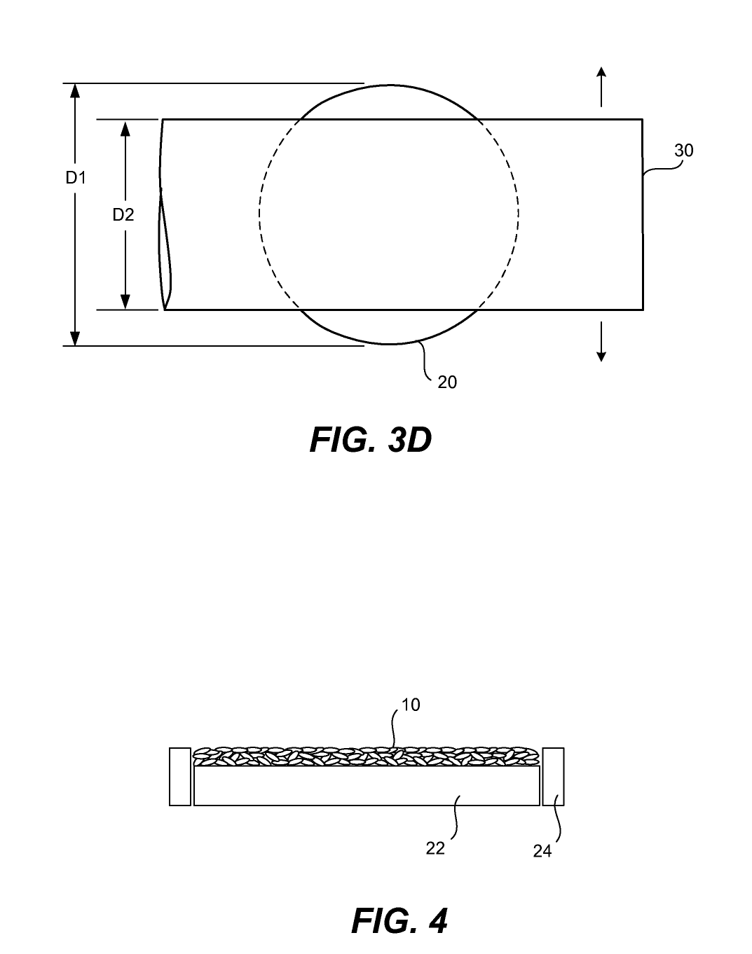

In accordance with one embodiment of the present invention, the cooked rice may be placed in the center portion of the mold 20, as shown in FIG. 3A. The cooked rice may be freshly cooked rice, and it is preferable that the cooked rice is equal to or less than 180° F. The cooked rice may be warm (for example, about 80° F.) or at the room temperature. The cooked rice is pressed into the mold 20 using a compressing tool 30 so as to be formed into a sheet-shape. The cooked rice may be pressed downward first and then spread out toward the both sides using the compressing tool 30, as shown in FIGS. 3B-3C. The compressing tool 30 may be a rolling pin or the like having a diameter D2 smaller than the diameter D1 of the mold 20, as shown in FIG. 3D. If the mold 20 has the diameter of 6 inches, the compressing tool 30 may have the diameter D2 of 4 inches, for example.

More generally, the compressing tool 30 may have a convex surface or at least partially cylindrical surface such that the direction of a pressing force applied to the cooked rice changes as the compressing tool moves or rolls over the cooked rice. Thus, the cooked rice is compressed by the pressing force not only in the vertical direction (with respect to an upper surface of the base 22), but also in oblique directions, up to the horizontal direction. As a result, the cooked rice grains are compressed and filled the space formed by the base 22 and ring 24 of the mold 20, as shown in FIG. 4. The cooked rice leaves little or no air space between or among the rice grains in the rice sheet 10, such that the rice sheet 10 has a high filling ratio. The cooked rice may brim over from the mold 20, but the uniform thickness of the rice sheet 10 is ensured as the compressing tool 30 moves by abutting the rim of the ring 24.

In accordance with one embodiment of the present invention, the compressing tool 30 reciprocates over the mold 20 such that the cooked rice is compressed by a pressing force varying from a first direction (a first force vector) to a second direction (a second force vector) via the vertical direction (a vertical force vector). The first and second force vectors have respective horizontal components in opposite directions. Thus, each portion of the cooked rice in the mold 20 is compressed in at least three different directions.

Since the direction of compression (angle of the pressing force) varies during the compressing process, the air can easily escape so as to prevent forming air spaces within the rice sheet 10. Such an air space would cause the rice sheet 10 to break when the rice sheet is folded or rolled to wrap an ingredient therein. In addition, by compressing or kneading the cooked rice in different directions, uniformity of the rice sheet 10 and adherence among cooked rice grains are improved, compared with compressing the cooked rice only in one direction, typically in the vertical direction (i.e., simply pressing from the above). By reducing the air spaces, freshness of the rice sheet 10 lasts longer. Being compressed, the cooked rice grains may be partially crushed such that starch comes out from inside of the cooked rice grains to the surface so as to enhance the stickiness of the cooked rice grains. Since cooked rice grains as well as connections between and among the cooked rice grains are flexible, the rice sheet 10 as a whole is also flexible like a rubber sheet. Thus, the rice sheet 10 retains integrity without cracks when folded to enclose an ingredient therein.

After being removed from the mold 20, the rice sheet 10 may be stored in such a condition that the rice sheet 10 is not drying. The surface of the rice sheet 10 loses stickiness or adhesiveness when the rice sheet 10 is cooled down to 10° C. or lower. The rice sheet 10 may be left under the room temperature to cool down, or cooled in a refrigerator or the like.

It should be noted that the mold 20 is not limited to the base-and-ring mold explained above, but can be selected in accordance with a specific use thereof. For example, when the rice sheet 10 is used for a sushi-roll like product, it may be a rectangular having a size of 5.9×9.8 inches (150 mm×250 mm). A round shape of the rice sheet with a diameter of 6 inches may be suitable for wrapping an ingredient for one serving. A larger-seized rice sheet can be cut into smaller sheets having a desired size and shape.

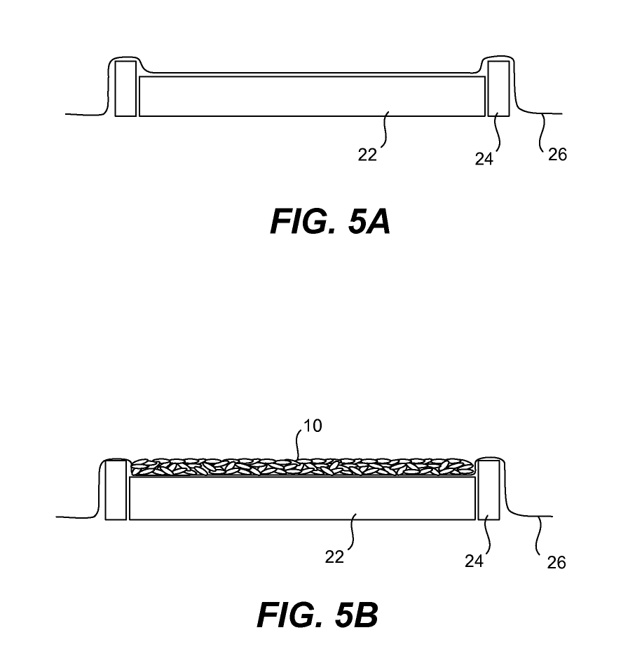

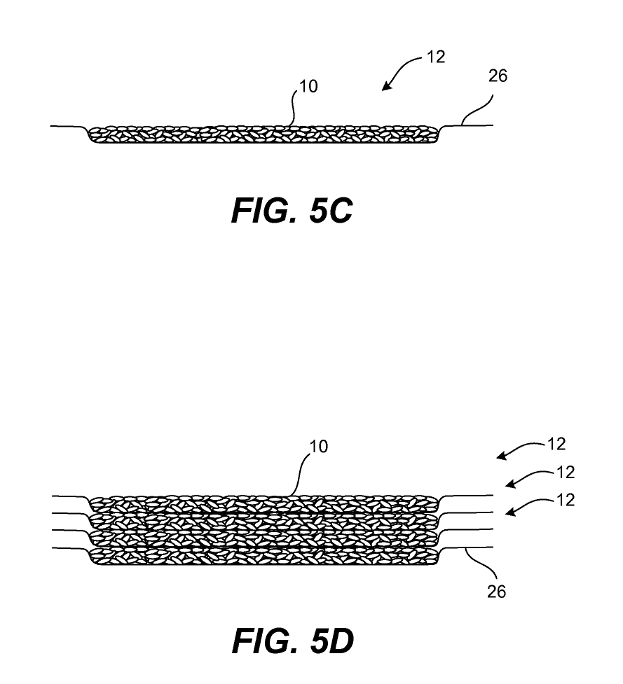

In accordance with one embodiment of the present invention, as shown in FIG. 5A, the mold 20 may be covered with a food wrapping film (cling wrap) 26 the cooked rice is placed in the mold 20. That is, the food wrapping film 26 is provided between the rice sheet 10 and the mold 20 when the cooked rice is being formed into the rice sheet 10 as shown in FIG. 5B. Although the mold 22 may be formed of such a material that the rice sheet 10 is easily separated therefrom, or may be Teflon®-coated, providing the food wrapping film 26 between the rice sheet 10 and the mold 20 allows the rice sheet 10 to be removed from the mold 20 more easily by pealing the food wrapping film 26 off the mold 20. The resultant film-lined rice sheet 12 is the rice sheet 10 having the food wrapping film 26 on a surface thereof. The film-lined rice sheet 12 can be handed easier than the rice sheet 10 without the food wrapping film 26, especially when the surfaces of the rice sheet 10 are still sticky. Providing the wrapping film 26 also help preventing the rice sheet 10 from drying. A plurality of film-lined rice sheets 12 may be stacked for storage or packaging such that the exposed upper surface of the rice sheet 10 is covered by the food wrapping film 26 of the adjacent film-lined rice sheet 12, as shown in FIG. 5D.

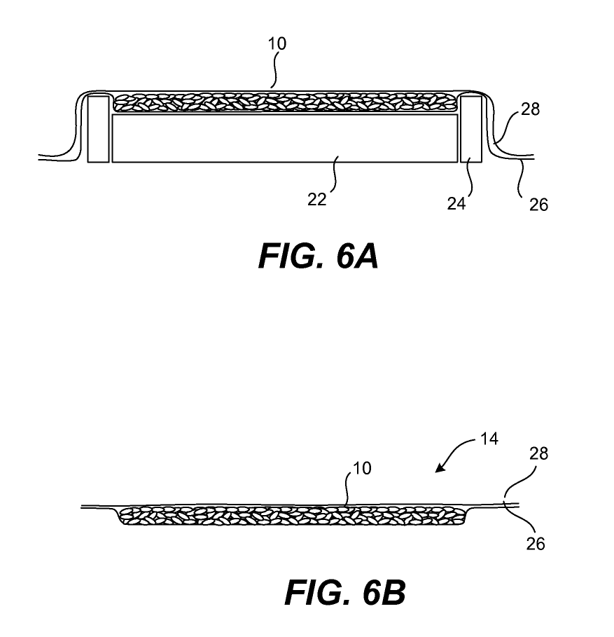

Furthermore, in accordance with one embodiment of the present invention, another food wrapping film 28 may be provided on the rice sheet 10 before the rice sheet 10 is removed from the mold 20, as shown in FIG. 6A. The compressing tool 30 may be used to line the food wrapping film 28 onto the rice sheet 10 in the mold 20. FIG. 6B shows a resultant film-lined rice sheet 14 having the food wrapping films on both of the surfaces. The film-lined rice sheet 14 prevents the rice sheet 10 from drying and sticking to fingers or the like when it is being handled. Thus, film-lined rice sheet 14 is advantageous when the rice sheet is stored, or otherwise is not immediately used for food preparation. The food wrapping films 26 and 28 may be removed from the rice sheet 10 before use.

The surfaces of the rice sheet 10 freshly made are sticky, and also the surfaces of the rice sheet 10 in the film-line rice sheet 12 or 14 from which the wrapping films 26 and/or 28 are removed also sticky. Thus, in accordance with one embodiment of the present invention, the surfaces of the rice sheet 10 may be dried to reduce the adhesiveness or stickiness of the surfaces such that the rice sheet 10 may be handled without sticking to a hand or fingers. The rice sheet is dried such that only the surfaces are dried, and the inside of the rice sheet 10 remains moist, flexible, and adhesive/sticky. As the inside of the rice sheet 10 maintains the moisture and softness, the rice sheet 10 can be folded without cracks. When the rice sheet 10 is bent, folded, or rolled, portions of the rice sheet 10 may be pressed to each other such that the pressed portions stick together and maintain the bent, folded, or rolled shape of the rice sheet 10 so as to hold ingredient therein.

The surfaces of the rice sheet 10 may be dried by heating, such as toasting, pan-frying, plate-grilling, roasting, and the like. An oven, toaster, toaster-oven, frying pan, hot plate, iron plate, and the like can be used to heat-dry the surfaces of the rice sheet 10. A microwave oven may also be used. The heat-dried surfaces of the rice sheet lose the stickiness, while the stickiness/adhesiveness among the cooked rice grains inside the rice sheet 10 is enhanced by such a heating. The surface of the rice sheet 10 is heated evenly, for example at 375 to 400° F. The time and temperature of such a heating process are adjusted such that only the surfaces are dried to lose the stickiness while the rice sheet 10 maintains its flexibility. An excess heat-drying may cause the rice sheet 10 to crack when it is folded or rolled, while the surface of the rice sheet 10 remains sticky by an insufficient heat-drying. The rice sheet 10 may be toasted/roasted/grilled brown to provide flavorful aroma and/or crispiness at edges.

The surfaces of the rice sheet 10 may also be dried by exposing to hot air, or blowing the hot air thereto. The air may also be at the room temperature. The inside of the rice sheet 10 keeps the moisture.

In accordance with the embodiments of the present invention, the rice sheet 10 with non-sticking surfaces and a soft and moist inside is achieved without adding rice powder, potato starch, and the like, preserving the original taste and mouth feel of the cooked rice.

In accordance with one embodiment of the present invention, white rice and brown rice may be cooked separately and mixed together when the two types of rice are placed in the mold 20. The white and brown rice may be mixed evenly before placing in the mold 20, or placed in the mode 20 together such that a certain brown/white pattern is formed when shaped into the rice sheet 10. Such a pattern may be enjoyable to the eye when a food product using the rice sheet 10 is consumed.

The cooked rice may be seasoned with rice vinegar and the like before being shaped into the rice sheet 10. The seasoning may be in a liquid, paste, or powder form. Rice vinegar may be used when the rice sheet 10 is used to wrap sushi ingredients, such as slices of raw fish such as tuna, sermon, sea bream, octopus, squid, shrimp, yellow tail, and the like, eggs, slices of cucumbers or white radish, lettuces, sprouts, avocados, and the like. Sugar and cream or milk can be used a seasoning for a crape or rice-pudding like taste. Chocolate powder, green tea powder, roasted soybean powder, and the like may also be used as a seasoning. Soy sauce, horse radish, ginger, mustard, mayonnaise, sesame seeds, and the like may also used as a seasoning. Various fruit flavors can also used as a seasoning. The seasoning may be mixed with the cooked rice before formed into the rice sheet, or applied to the rice sheet 10 after removed from the mold 20. Some seasonings may be applied to the rice sheet 10 after heat-drying.

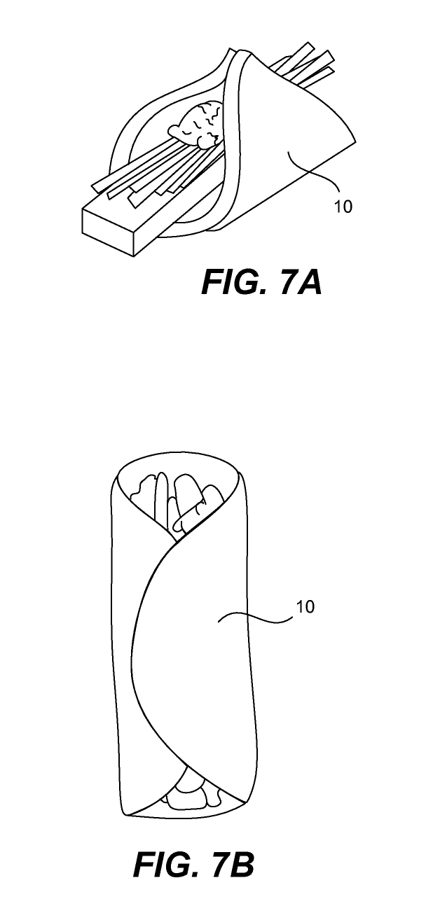

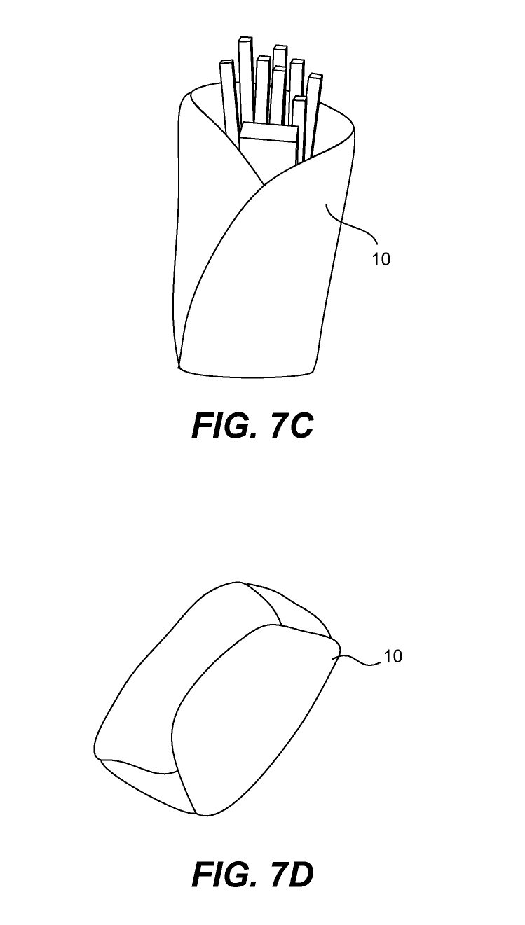

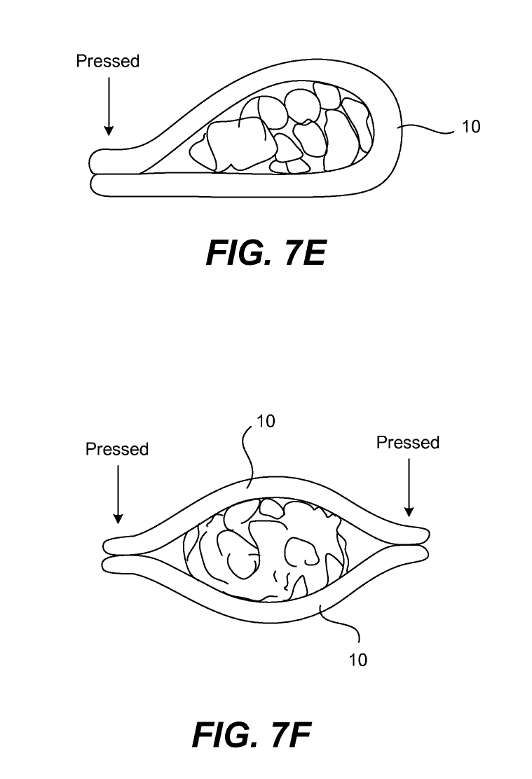

The thus made rice sheet 10 is non-sticking when handled, especially by hand, and yet is able to be fold or rolled without braking or cracking. In accordance with one embodiment of the present invention, a food product is made by wrapping food ingredients with the rice sheet 10. FIGS. 7A through 7G show examples of the food products made of the rice sheet 10 with ingredients held therein. As shown in FIG. 7A, food ingredients are wrapped with the rice sheet 10 by placing the ingredients on a center portion of the rice sheet 10, and then lifting and pinching the both ends together. The pinched portions stick to each other so as to hold the ingredients. The “wrapping” may be rolling the rice sheet 10 with the ingredients therein, as shown in FIG. 7B. The overlapped portions of the rice sheet 10 are pressed to adhere to each other. Such a rice-sheet roll may be cut into a half to have a suitable size, as shown in FIG. 7C. The rice sheet 10 may be uses to wrap ingredients in a burrito-like manner, as shown in FIG. 7D. The “wrapping” may be folding in half with ingredients therein and sealing the edges by pressing, as shown in FIG. 7E which shows a cross-sectional view. Two rice sheets 10 may be used to sandwich ingredient therebetween and seal the edges by pressing, as shown in FIG. 7F.

The ingredients may be sushi ingredients as mentioned above. The ingredients may be a various types of paste, such as red bean paste, sweet potato paste, pumpkin paste, jams and jerry, fruits, whip or custard cream, and the like. In addition, the ingredients may be cooked beef, pork, or chicken (marinated), cooked sea food, with or without lettuces, tempra or fritters, and the like.

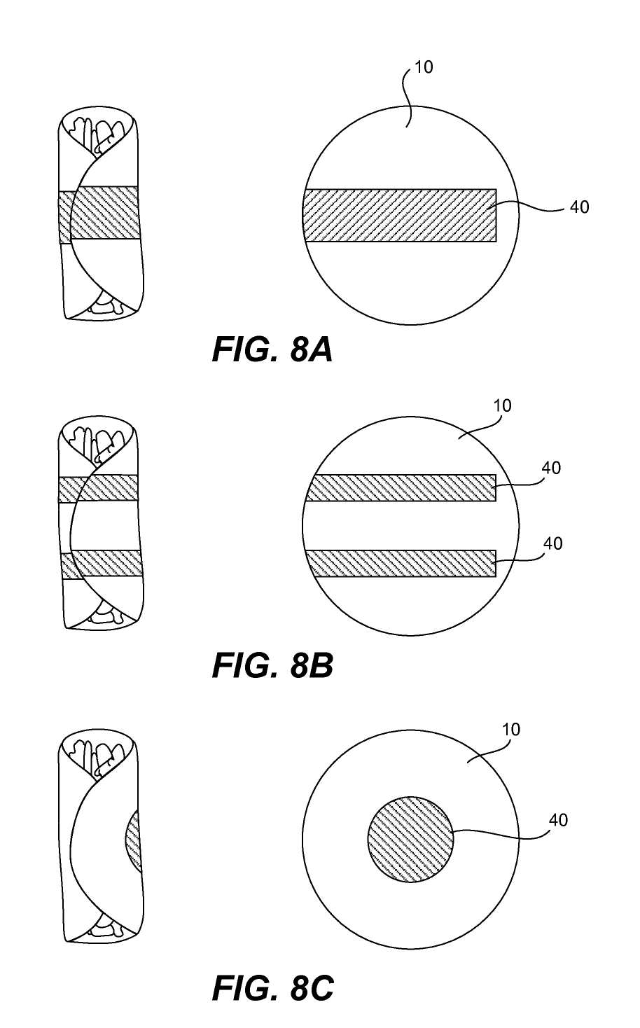

In accordance with one embodiment of the present invention, a patterned seaweed paper (nori) may be placed on surface of the rice sheet 10, as shown in FIGS. 8A to 8C. Such seaweed patterns may be attached to the rice sheet 10 before the heat-drying process. Providing a set of the rice sheets 10 with different seaweed patterns allows food products to have markings indicating the respective ingredients. For example, a one-seaweed band pattern indicates a first food ingredient (e.g., tuna), a two-seaweed band pattern indicates a second food ingredient (e.g., salmon), and a dot pattern indicates vegetarian gradients, and the like. In order not to hinder the adhesiveness of the rice sheet 10 at its edge portion, such a seaweed pattern may be placed avoiding the edge portions of the rice sheet 10. Alternately, a seaweed paper may be applied to the food product after it has been made.

In accordance with one embodiment of the present invention, the rice sheet 10 may contain a food coloring additive to enhance a delicious look of the food product and/or indicating the ingredient or flavor. For example, a pink color may use to indicate red bean paste, a yellow color to indicate pumpkin paste.

While this invention has been described in terms of several preferred embodiments, there are alterations, permutations, modifications, and various substitute equivalents, which fall within the scope of this invention. It should also be noted that there are many alternative ways of implementing the methods and apparatuses of the present invention. It is therefore intended that the following appended claims be interpreted as including all such alterations, permutations, and various substitute equivalents as fall within the true spirit and scope of the present invention.

What is claimed is:

1. A rice sheet formed of cooked rice, wherein the cooked rice is compressed into a sheet-shape to have a reduced volume which is equal to or less than one half of an original volume of the cooked rice before the compression.

2. The rice sheet of claim 1, wherein the rice sheet has a thickness less than 3 mm.

3. The rice sheet of claim 1, wherein the rice sheet has a thickness between 3 mm to 8 mm.

4. The rice sheet of claim 1, wherein the reduced volume is about one half of the original volume.

5. The rice sheet of claim 1, wherein the rice sheet is capable of being folded or rolled to hold an ingredient therein without cracking.

6. The rice sheet of claim 1, wherein at least one surface of the rice sheet is dried to reduce stickiness thereof while an inside of the rice sheet maintains softness and moisture to be folded or rolled without cracks.

7. The rice sheet of claim 6, wherein when the rice sheet is folded or rolled, overlapping portions of the rice sheet are capable of adhering to each other when pressed onto each other.

8. The rice sheet of claim 1, wherein a direction of a compressing force applied to the cooked rice changes during the compression.

9. The rice sheet of claim 1, wherein the cooked rice includes white cooked rice and brown cooked rice.

10. The rice sheet of claim 1, wherein the rice sheet contains a seasoning which has been mixed with the cooked rice.

11. The rice sheet of claim 1, wherein the rice sheet includes a seasoning applied to a surface thereof.

12. The rice sheet of claim 1, wherein the rice sheet has a patterned seaweed paper on a surface thereof.

13. A food product comprising:
the rice sheet of claim 1; and
an ingredient wrapped with the rice sheet,
wherein the rice sheet does not have cracks where the rice sheet is folded.

14. The food product of claim 13, wherein the rice sheet having overlapping portions pressed to each other so as to retain a wrapping shape thereof.
